(19) United States
(12) Patent Application Publication
(10) Pub. No.: US 2008/0087120 A1
(43) Pub. Date: Apr. 17, 2008

(54) SHIFT MECHANISM FOR MANUAL TRANSMISSION

(75) Inventors: Takahiro Nakane, Nukata-gun (JP); Toshio Tanba, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI Co., Ltd., Nishio-shi (JP)

(21) Appl. No.: 11/830,037

(22) Filed: Jul. 30, 2007

(30) Foreign Application Priority Data
Jul. 31, 2006 (JP) 2006-207927

(51) Int. Cl. F16H 63/08

(52) U.S. Cl. 74/335

(57) ABSTRACT

A shift mechanism for a manual transmission includes a shaft rotatably and reciprocatably supported by a housing, a shift rail axially movably supported by the housing and reciprocated in conjunction with rotation of the shaft, a shift fork attached to the shift rail for selecting and establishing one of a plurality of shift stages, an inertia lever attached to the housing and pivoted in conjunction with the rotation of the shaft, an inertia mass provided at one end of the inertia lever, and a guide pin provided at the inertia mass in parallel with a central axial line of the shaft and protruding from the inertia mass so that the guide pin is engaged with a cam groove being provided at a flat panel which is formed on the housing orthogonally with the central axial line of the shaft, wherein a profile of the cam groove is formed on the flat panel.

### CROSS REFERENCE TO RELATED APPLICATIONS

This application is based on and claims priority under 35 U.S.C. § 119 to Japanese Patent Application 2006-207927, filed on Jul. 31, 2006, the entire content of which is incorporated herein by reference.

### FIELD OF THE INVENTION

The present invention relates to a shift mechanism for a manual transmission, more specifically, the present invention relates to a shift mechanism for a manual transmission which includes an inertia mass provided at an inertia lever oscillated in conjunction with rotation of a shaft that reciprocates a shift rail.

### BACKGROUND

A synchronizing clutch mechanism, which is applied to a gear type manual transmission, has an operating characteristic of a clutch, which is a so-called ‘dual engaging’ characteristic. Therefore, a shift feeling is degraded because of an operating force discontinuously changing during a shift change operation. Moreover, for example, a front-engine, front wheel type vehicle includes a shift mechanism wherein the synchronizing clutch mechanism is operated by means of a gear lever provided in the vicinity of a driver's seat via a cable type synchronizing mechanism. However, the cable type synchronizing mechanism has a large deflection. Therefore, discontinuity in the changes of the operating force during the shift change operation is further increased, and further degrading the shift feeling.

To improve the above-mentioned degradation during the shift change operation, for example, JP2003106449 discloses a shift mechanism that includes an inertia mass provided at an inertia lever oscillated in accordance with rotation of a shaft that reciprocates a shift rail. In JP2003106449A, a first embodiment of the know achieves the smooth shift feeling by providing the inertia mass directly arranged at one end of an outer lever, which results in decreasing a peak load applied to the gear lever during the shift change operation. The other end of the outer lever is connected to a shift cable, and further the outer lever is oscillated in accordance to rotation of a shift and select shaft as an axis. Moreover, as a second embodiment of the known art, in JP2003106449A, the shift mechanism having an inertia lever is disclosed. The inertia lever includes the inertia mass and is arranged in parallel with an outer lever. The outer lever, whose one end is connected to the shift cable, is oscillated around the shift and select shaft. Furthermore, as a third embodiment of the known art disclosed in JP2003106449A, the shift mechanism for an automotive manual transmission includes an outer lever, which moves around a shift and select shaft. The outer lever is connected to a shift cable at its one end, and further the outer lever is moved in an axial direction of the shift and select shaft. In this shift mechanism for the automotive manual transmission, an inertia lever includes an inertia mass and is vertically engaged with the outer lever so that the inertia lever is moved in accordance to oscillation of the outer lever.

As shown in JP2003106449A, by providing the inertia mass at the inertia lever, the smooth shift feeling is realized during a shift change operation. However, while the vehicle is moving after the shift change operation is completed, the inertia mass increases vibration transmitted to the outer lever from an engine and a transmission. Further, the increased vibration is transmitted to the manual gear lever provided in the vicinity of the driver's seat through a cable or the like. Hence, the shift mechanisms disclosed in JP2003106449A increases vibration transmitted to the gear lever.

A need thus exists to provide a shift mechanism which is not susceptible to the drawback mentioned above.

### SUMMARY OF THE INVENTION

According to an aspect of the present invention, a shift mechanism for a manual transmission includes a shaft rotatably and reciprocatably supported by a housing, a shift rail axially movably supported by the housing and reciprocated in conjunction with rotation of the shaft, a shift fork attached to the shift rail for selecting and establishing one of a plurality of shift stages by reciprocation of the shift rail, an inertia lever attached to the housing and pivoted in conjunction with the rotation of the shaft, an inertia mass provided at one end of the inertia lever, the end portion of the inertia lever being distant from a central axial line of the shaft and a guide pin provided at the inertia mass so as to extend in parallel with a central axial line of the shaft and protruding from the inertia mass so that the guide pin is engaged with a cam groove being provided at a flat panel which is formed on the housing orthogonally with the central axial line of the shaft, wherein a profile of the cam groove is formed on the flat panel so that the inertia mass is moved in a radial direction of the inertia lever in conjunction with the rotation of the shaft in a manner where, when the inertia lever is in a neutral position, a distance between the inertia mass and the central axial line becomes larger than the distance spaced between the inertia mass and the central axial line when one of the plurality of the shift stages is established by means of the shift fork.

### BRIEF DESCRIPTION OF THE DRAWINGS

The foregoing and additional features and characteristics of the present invention will become more apparent from the following detailed description considered with the reference to the accompanying drawings, wherein:

FIG. 1 illustrates a cross sectional view showing overall structure of one example of embodiments related to a shift mechanisms of a manual transmission of the present invention;

FIG. 2 illustrates a right side view of an inertia lever, an inertia mass and a cam groove when the inertia lever is in neutral;

FIG. 3 illustrates a right side view of the inertia lever being moved to an approximate end of an upper portion of the cam groove; and

FIG. 4 illustrates a right side view of the inertia lever being moved to an approximate end of a side portion of the cam groove when a shift operation is completed.

### DETAILED DESCRIPTION

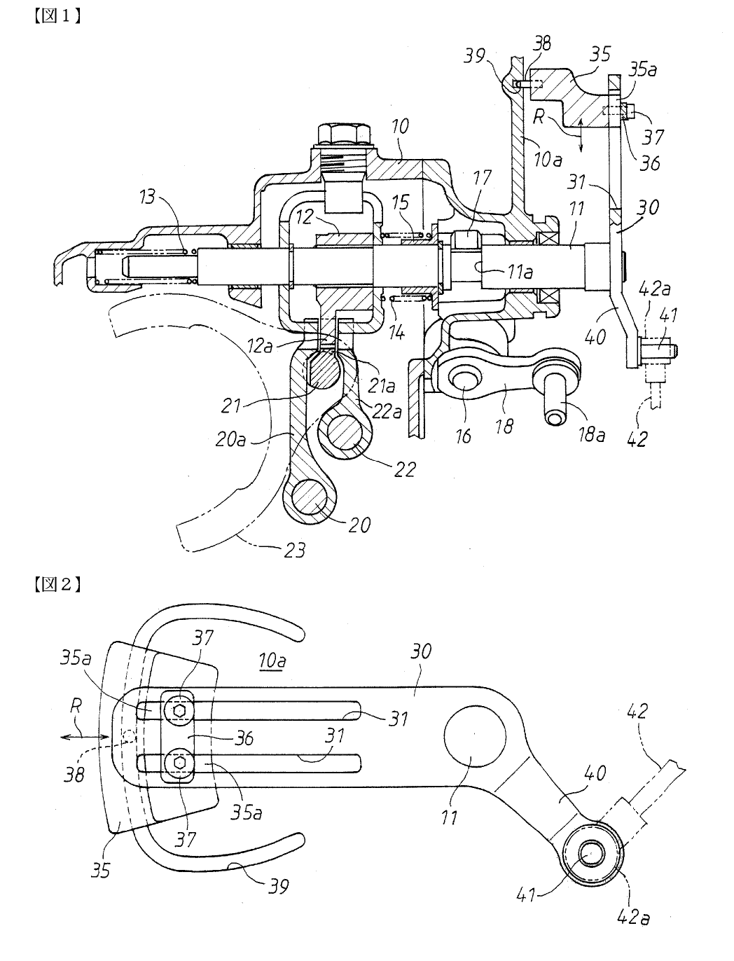

An embodiment of the present invention of a shift mechanism for a manual transmission will be explained in accordance with FIG. 1 through FIG. 4 of the attached drawings. The shift mechanism for the manual transmission of the present invention includes a housing 10, a shift and select shaft 11 (a shaft 11) and three shift rails 20, 21 and 22. The housing 10 includes an outer housing and an inner housing that are integrally fixed with each other by means of a screw or the like, and further a gear selecting type transmission (not shown) is arranged within the housing 10. The shift and select shaft 11 is rotatably and axially movably inserted through the housing 10. The axially movable three shift rails 20, 21 and 22 are linked to the shift and select shaft 11, and further the three shift rails 20, 21 and 22 are orthogonally arranged with the shift and select shaft 11. Three shift forks are fixed to each of the shift rails 20, 21 and 22 respectively. For convenience, one of three shift forks (a shift fork 23) is described with a chain double-dashed line in FIG. 1. According to FIG. 1, the shift fork 23 is fixed to the shift rail 21. The shift fork 23 is operated to change a shift gear by being engaged with a part of the gear selective type transmission, for example, a clutch hub sleeve of a synchronizing clutch mechanism (not shown).

Each of shift heads 20a, 21a and 22a (a first shift head 20a, a second shift head 21a and a third shift head 22a) is integrally formed at each of the shift rails 20, 21 and 22 respectively. A recessed portion is formed at an end portion of each of the shift heads 20a, 21a and 22a, each of the recessed portions is formed in the same dimension. Further, each of the end portions of the shift heads 20a, 21a and 22a is superposed with each other and a certain space is retained therebetween. A shift head member 12 is fixed at an intermediate portion of the shift and select shaft 11 by means of, for example, a spline and a pin. The shift head member 12 has a head portion 12a that protrudes from the shift head member 12 in a radial direction thereof. Further, the protruding portion is formed to be engagable with each of the recessed portions of the shift heads 20a, 21a and 22a with keeping slight spaces therebetween. The shift and select shaft 11 is biased from both sides by a flange 15, a first spring 13 and a second spring 14, which are interposed within the housing 10. A biasing force of the first spring 13 is set to be smaller than that of the second spring 14. Hence, when the gear lever is positioned in neutral, the head portion 12a of the shift head member 12 is engaged with the recessed portion of the first shift head 20a.

As shown in FIG. 1, a groove portion 11a in a cylindrical form is formed at a part of the shift and select shaft 11 within the housing 10. A select shaft 16 is rotatably supported by the housing 10 at a position corresponding to the groove portion 11a of the shift and select shaft 11. The select shaft 16 is arranged so as to extend in a direction being orthogonal to the shift and select shaft 11. A select shaft 16 includes one end portion and an other end portion. The one end portion of the select shaft 16 is fixed to a select lever 18 by means of a rivet or the like. The select shaft 16 protrudes from the housing 10 in a radial direction of the select shaft 16. A select arm 17 is fixed at the other end portion of the select shaft 16 within the housing 10 by means of a pin or the like. The select arm 17 is engaged with the groove portion 11a of the shift and select shaft 11. A select cable pin 18a is fixed at an end portion of the select lever 18 by means of a rivet or the like, and is arranged in parallel with the select shaft 16. The select cable pin 18a is linked to a gear lever arranged in the vicinity of the driver's seat via a shift cable (not shown), which is similar to a shift cable 42. The select lever 18 swings in conjunction with the select cable being pulled or loosened. Then, the shift and select shaft 11 is reciprocated in an axial direction thereof via the select shaft 16 and the select arm 17.

As shown in FIG. 1, an end portion of the shift and select shaft 11, which is projected to the right side of the housing 10, is fixed at a bottom end portion of an inertia lever 30, to which an inertia mass 35 (which will hereinafter be described in detail) is attached. A thick plate is used to form the inertia lever 30. A shifter arm 40 is integrally formed at the bottom end portion of the inertia lever 30 so that the shifter arm 40 is radially protruded and extends to the inertia lever 30. A shift cable pin 41 is fixed at an end portion of the shifter arm 40 by means of a rivet or the like. The shift cable pin 41 extends in parallel with a central axial line of the shift and select shaft 11. The central axial line of the shift and select shaft 11 functions as a central axis point when the inertia lever 30 moves in an arch. A connecting member 42a is provided at one end of the shift cable 42 and is connected to the shift cable pin 41. Further, the other end of the shift cable 42 is connected to the gear lever provided in the vicinity of the driver's seat (not shown). A torsion spring (not shown) elastically biases the shift and select shaft 11 in an opposite rotational direction of the shift and select shaft 11 being rotated by the select shaft 16 and the select arm 17 when the shift cable 42 is pulled. In this configuration, the shifter arm 40 is pivoted and the shift and select shaft 11 is rotated by pulling and loosening the shift cable 42 by means of the gear lever.

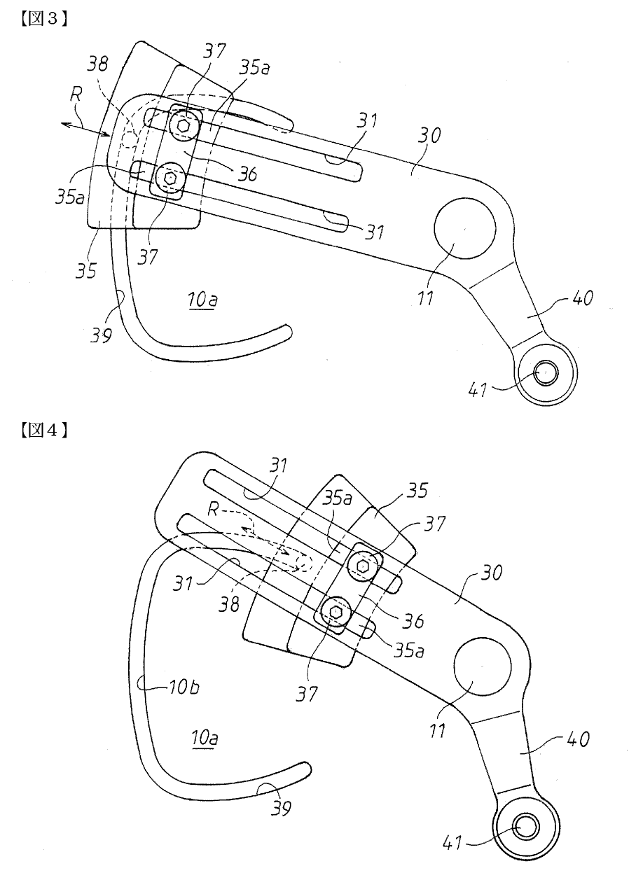

A shown in FIG. 1, the inertia lever 30, to which the inertia mass 35 is provided, is made of a thick plate having a certain width. As shown in FIG. 2 through FIG. 4, the inertia lever 30 is attached to one end portion of the shift and select shaft 11 and extends in a radial direction from the shift and select shaft 11. A pair of guide grooves 31 is formed on the inertia lever 30 in parallel to each other. The pair of the guide grooves 31 outwardly extends in radial direction of the inertia lever 30 along a longitudinal side thereof and further, the length of the pair of guide grooves 31 is longer than half the length of the inertia lever 30. The inertia mass 35 is formed in an approximate Z-shape in a cross-sectional diagram illustrated in FIG. 1 and is formed in an approximate sector in a plain view. A pair of protrusions 35a is integrally formed on the right side of the inertia mass 35 as shown in FIG. 1. The pair of protrusions 35a is provided at the inertia lever 30 in parallel to each other as shown in FIG. 1 and FIG. 2. Furthermore, the pair of protrusions 35a is formed to be slightly thicker than the thickness of the inertia lever 30. When referring to the longitudinal side of each of the guide grooves 31 as length and referring to the shorter side of each of the guide grooves 31 as width, the width of each of the protrusions 35a corresponds to the width of each of the guide grooves 31. The protrusions 35a are engaged with the guide grooves 31 respectively so as to be slidable in a longitudinal direction of the guide grooves 31. In practice, each of the protrusions 35a slide from one end of each of the guide grooves 31 to the other end of each of the guide grooves 31. A holding plate 36 is attached at right-side surfaces of the protrusions 35a in FIG. 1 by means of, for example, hexagon socket cap screws so that the inertia mass 35 is prevented from being disengaged from the inertia lever 30, and so that the inertia mass 35 slides in a longitudinal direction of the inertia lever 30 (in the arrow R direction in FIG. 1, FIG. 2 and FIG. 3).

As shown in FIG. 1 through FIG. 4, a flat panel 10a is formed at an approximate one end of the housing 10 at the side of the inertia lever 30. Specifically, the flat panel 10a is orthogonally formed on the housing 10 relative to the central axial line of the shift and select shaft 11, which functions as the central axis point around which the inertia lever 30 moves in the arch. A cam groove 39, formed in an approximate C-shape, as shown in FIG. 2, is provided on a surface of the flat panel 10a facing the inertia lever 30. As shown in FIG. 2, the cam groove 39 is formed in an approximate arc shape and is symmetrical with respect to a horizontal line along the inertia lever 30 (a symmetrical axis). The horizontal line is running through the central axis point of the shift and select shaft 11. The point where the horizontal line crosses the cam groove 39 is referred to as a symmetrical point. The cam groove 39 is formed with a large arc having a large radius, two small arcs each having a small radius and two large arcs each having a large radius. The large arc having the large radius corresponds to the distance between the central axis point of the shift and select shaft 11 and the symmetrical point of the cam groove 39. Each of the small arcs having the small radius smoothly continues from each end of the large arc having the large radius and curves towards the shift and select shaft 11. Each of the large arcs having the large radius smoothly continues from each of the small arcs having the small radius and curves towards the shift and select shaft 11. Hereinafter, the large arc having the large radius, which corresponds to the distance between the central axis point of the shift and select shaft 11 and the symmetrical point is referred to as a main portion of the cam groove 39. The rest of the portions of the cam groove 39, which curve towards the shift and select shaft 11, are referred to as side portions of the cam groove 39. A guide pin 38 is provided on a surface of the inertia mass 35 facing the flat panel 10a so that the guide pin 38 engages with the cam groove 39. Further, the guide pin 38 is provided on the surface of the inertia mass 35 in parallel with the shift and select shaft 11. When the gear lever is shifted to neutral, where any shift stages are not established, the inertia lever 30 is maintained at the position shown in FIG. 2. Further, in this case, the guide pin 38 is positioned on the symmetrical point of the cam groove 39.

Hereinafter, an operation of the shift mechanism of the above-mentioned embodiment will be described in detail. The gear lever provided in the vicinity of the driver's seat is operated in two different shift directions (a shift direction) and in two different select directions (a select direction). When the gear lever is operated to a middle position in the select direction (when the gear lever is positioned to neutral), as shown in FIG. 1, the head portion 12a of the shift head member 12 is engaged with the recessed portion of the second shift head 21a. When the gear lever is operated in one direction of the select direction from neutral, the shift and select shaft 11 is moved in the left direction in FIG. 1 via the select cable, the select lever 18, the select shaft 16 and the select arm 17 so that the head portion 12a is engaged with the recessed portion of the first shift head 20a. Similarly, when the gear lever is operated in the other direction of the select direction from neutral, the shift and select shaft 11 is moved to the right direction in FIG. 1 via the select cable, the select lever 18, the select shaft 16 and the select arm 17 so that the head portion 12a is engaged with the recessed portion of the third shift head 22a.

When the gear lever is positioned in neutral under a condition where the head portion 12a of the head member 12 is engaged with either of the first shift head 20a, the second shift head 21a or the third shift head 22a, each of the shift rails 20, 21 and 22 remains in neutral. Therefore, for example, the shift fork 23 in FIG. 1 is not engaged with an appropriate clutch hub sleeve of the synchronizing clutch mechanism and further, the synchronizing clutch mechanism is not engaged with any shift gears provided at both sides of the synchronizing clutch mechanism. When the gear lever is operated in one direction of the shift direction under the above-mentioned condition, the shift cable 42 is loosened and the shift and select shaft 11 is rotated in a clockwise direction in FIG. 2 through FIG. 4 by means of the torsion spring (not shown) so that the head portion 12a is engaged with the recessed portion of one of the shift heads 20a, 21a and 22a. By doing so, for example, the shift rail 21 moves in a pulling direction in FIG. 1 and then the shift fork 23 provided at the shift rail 21 is engaging with the synchronizing clutch mechanism corresponding to the shift fork 23 and then the synchronizing clutch mechanism is engaged with one of the gears provided at the both sides of the synchronizing mechanism in order to establish a certain shift gear train corresponding to the gear lever operation. Additionally, when the gear lever is operated in the other direction of the shift direction from neutral, the shift cable 42 is pulled and the shift and select shaft 11 is rotated in a counterclockwise direction in FIG. 2 through FIG. 4 by opposing the biasing force of the torsion spring. Then, for example, the shift rail 21 moves in a pushing direction in FIG. 1 and then the shift fork 23 provided at the shift rail 21 is engaged with the synchronizing clutch mechanisms corresponding to the shift fork 23. As a result, the synchronizing clutch mechanisms is engaged with the other of the gears provided at the both sides of the synchronizing mechanism in order to establish a certain shift gear train corresponding to the gear lever operation.

In any case mentioned above, while the inertia lever 30 pivots from the central position illustrated in FIG. 2 to, for example, an approximate one end of the main portion of the guide groove 39 illustrated in FIG. 3, the guide pin 38 slides along the main portion of the guide groove 39. Therefore, the distance between the inertia mass 35 and the central axis point of the shift and select shaft 11 is maintained nearly constant width, while the guide pin 38 slides along the main portion of the guide groove 39. However, after the inertia lever 30 reaches the one end of the main portion of the guide groove 39, the guide pin 38 slides along one of the side portions of the guide groove 39 as shown in FIG. 4, the inertia mass 35 moves steeply closer to the shift and select shaft 11. Further, as shown in FIG. 4, the inertia mass 35 moves downwards along the one of the side portions of the guide groove 39 to an approximate bottom end portion of the one side portion of the guide groove 39 when the appropriate shift stage is established. When the inertia mass 35 is positioned at the approximate bottom end portion of the one of the side portions of the guide groove 39, as shown in FIG. 4, the distance between the inertia mass 35 and the central axis point of the shift and select shaft 11 becomes further narrower.

Generally, in a synchronizing clutch mechanism having a synchronizer ring provided to a gear type manual transmission, when the gear lever is operated to establish a gear speed appropriate to a condition of a vehicle, firstly, an internal spline of a clutch hub sleeve is engaged with external spline of the synchronizer ring by means of the shift fork 23. Then, the internal spline of the clutch hub sleeve further moves to engage with the external spline of a gear piece fixed on a shift gear. As a result, the internal spline of the clutch hub sleeve is engaged both with the external spline of the synchronizer ring and the external spline of the gear piece. Therefore, the synchronizing clutch mechanism is so called ‘dual engaging’ clutch operating characteristics. This synchronizing clutch mechanism causes a degradation of the shift feeling because of control force discontinuously changing during the shift change operation. However, according to the above-mentioned embodiment, when the gear lever is positioned in neutral in order to be ready to change a next gear speed, the guide pin 38 fixed at the inertia mass 35 is positioned on the symmetrical point of the cam groove 39. In this case, the distance between the inertia mass 35 and central axis point of the shift and select shaft 11 is large. Further, a moment of inertia generated at the inertia mass 35 relating to the shift and select shaft 11 also becomes large. Therefore, in discontinuous changes of the control force are restrained, which results in realizing the smooth shift feeling during the shift change operation. On the other hand, when the shift operation is completed, the guide pin 38 is positioned to the approximate end of one of the side portions of the cam groove 39, which results in shortening the distance between the inertia mass 35 and the shift and select shaft 11. Hence, the moment of inertia generated at the inertia mass 35 relative to the shift and select shaft 11 also becomes small. As a result, while the vehicle is driven, a level of the vibration, which is applied to the inertia lever 30 from and engine, a transmission or the like, being increased by the inertia mass 35, is reduced. Thus, vibration transmitted to the gear lever from the inertia lever 30 via the shift cable 42 is also reduced.

According to the above-mentioned embodiment, the inertia lever 30 is fixed to the shift and select shaft 11 and extends in a radial direction of the shift and select shaft 11. In this configuration, an attaching structure of the inertia lever 30 is simplified, which results in reducing manufacturing costs of the transmission. However, the present invention is not limited to the above-mentioned embodiment, but the present invention may be applied to a transmission, in which the inertia lever 30 is not directly attached to the shift and select shaft 11 as described in the second embodiment of the shift mechanism disclosed in JP2003106449.

In the above-mentioned embodiment, the inertia lever 30 made of the thick plate is fixed to the shift and select shaft 11. The inertia lever 30 includes the guide grooves 31 extending in a longitudinal direction of the inertia lever 30. The protrusions 35a are integrally formed on the inertia mass 35. The protrusions 35a are engaged with the guide grooves 31 respectively so that the protrusions 35a slidably moves in a longitudinal direction of the inertia lever 30. Hence, the inertia mass 35 is prevented from leaning to one direction or from being twisted, but the inertia mass 35 always reciprocates in a radial direction in conjunction with the movement of the inertia lever 30. Additionally, the attaching structure of the inertia mass 35 is simplified, which results in reducing the manufacturing costs of the transmission. The present invention is not limited to the above-mentioned embodiment, the present invention may be applied to shift mechanisms having various supporting structure for attaching the inertia mass 35, to the inertia lever 30.

Generally, the shift and select shaft 11 is rotated in a clockwise direction and in a counterclockwise direction via the shift cable 42, and then the shift rails 20, 21 and 22 are reciprocated by the rotation of the shift and select shaft 11. Because of the large deflection of the shift cable 42, the shift feeling is degraded during the shift change operation. A large inertia mass 35 may be provided to the shift mechanism in order to improve the shift feeling. However, by providing the large inertia mass 35, while the vehicle is driven, the vibration transmitted to the inertia lever 30 from the engine, the transmission or the like is increased by the large inertia mass 35. As a result, a large level if the vibration may be transmitted to the gear lever. Hence, the present invention functions appropriately for the shift mechanism of a manual transmission in which the shift and select shaft 11 is rotated via the shift cable 42.

Furthermore, in the above-mentioned embodiment, the shifter arm 40 is integrally formed at the inertia lever 30. The one end of the shift cable 42 is connected to the end portion of the shifter arm 40. By integrating the inertia lever 30 and the shifter arm 40, the structure of the shift mechanisms is further simplified and the manufacturing costs will be further reduced.

In the above-mentioned embodiment, each of the shift rails 20, 21 and 22 are in a neutral position where each of the shift forks 23 is not engaged with the corresponding clutch hub sleeve. When the gear lever is operated to change the gear speed, the appropriate shift rail 20, 21 or 22 reciprocates in both directions along the axial line of the shift rails 20, 21 and 22 respectively in order to be engaged with the appropriate clutch hub sleeve to change the shift gears. However, the present invention is not limited to the above-mentioned embodiment. Each of the shift rails 20, 21 and 22 may be reciprocated in one axial direction of each of the shift rails 20, 21 and 22 in order to change the shift gears depending on the structure of the transmission.

According to the embodiment of the present invention, the distance between the inertia mass 35 and the central axis point of the shift and select shaft 11 is large when the inertia lever is in the neutral position and the moment of inertia generated at the inertia mass 35 relative to the central axis point of the shift and select shaft 11 becomes also large. Therefore, by applying the present invention to the manual transmission, discontinuous changes of the operating force are reduced, which results in realizing smooth shift feelings during the shift change operation. On the other hand, the distance between the inertia mass 35 and the central axial point of the shift and select shaft 11 becomes small at the position where the inertia mass 35 is positioned when the shift operation is completed. The moment of inertia generated at the inertia mass 35 relative to the axis point of the shift and select shaft 11 also becomes small. Hence, while the vehicle is driven, the level of vibration, which is increased by the inertia mass 35 attached to inertia lever 30 and transmitted from the engine, the transmission or the like is reduced. As a result, the vibration transmitted to the gear lever from the inertia lever 30 via the shift cable 42 or the like is also reduced.

According to the embodiment of the present invention in which the inertia lever 30 is fixed at the shift and select shaft 11 and extends in the radial direction of the shift and select shaft 11, the attaching structure of the inertia lever 30 is simplified, and as a result, the manufacturing costs will be reduced.

According to the embodiment of the present invention, the inertia lever 30, which is made of a thick plate, is fixed at the shift and select shaft 11 and extends in the radial direction of the shift and select shaft 11, and further the inertia lever 30 includes the integrally formed protrusions 35a being engaged with and slidably moving along the guide grove 31 in a longitudinal direction of the inertia lever 30. In this configuration, the inertia mass 35 is always moved in a radial direction in conjunction with the movement of the inertia lever 30, and the attaching structure of the inertia mass 35 is simplified, which results in reducing the manufacturing costs.

Generally, in a shift mechanism for the manual transmission, the shift and select shaft 11 is rotated in the clockwise direction and in the counterclockwise direction in order to reciprocate the appropriate shift rails 20, 21 or 22 to change the gear speed. In this shift mechanism, the deflection of the shift cable 42 is large, which results in further degrading the shift feelings. By providing the large inertia mass, the shift feeling will be improved when the gear lever is operated to change the gear speed. Hence, the present invention is appropriate to be provided to the shift mechanism for the manual transmission wherein the shift and select shaft 11 is rotated via the shift cable 42 in order to reciprocate either shift rails 20, 21 or 22.

According to the embodiment of the present invention in which the shifter arm 40 is integrally provided to the inertia lever 30 and the one end of the shift cable 42 is connected to the end portion of the shifter arm 40. By integrating the inertia lever 30 and the shifter arm 4, the structure of the shift mechanism is simplified, which results in further reducing the manufacturing costs.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A shift mechanism for a manual transmission, comprising:
a shaft rotatably and reciprocatably supported by a housing;
a shift rail axially movably supported by the housing and reciprocated in conjunction with rotation of the shaft;
a shift fork attached to the shift rail for selecting and establishing one of a plurality of shift stages by reciprocation of the shift rail;
an inertia lever attached to the housing and pivoted in conjunction with the rotation of the shaft;
an inertia mass provided at one end of the inertia lever, the end portion of the inertia lever being distant from a central axial line of the shaft; and
a guide pin provided at the inertia mass so as to extend in parallel with a central axial line of the shaft and protruding from the inertia mass so that the guide pin is engaged with a cam groove being provided at a flat panel which is formed on the housing orthogonally with the central axial line of the shaft, wherein a profile of the cam groove is formed on the flat panel so that the inertia mass is moved in a radial direction of the inertia lever in conjunction with the rotation of the shaft in a manner where, a distance between the inertia mass and the central axial line becomes larger when the inertia lever is in a neutral position than the distance spaced between the inertia mass and the central axial line when one of the plurality of shift stages is established by means of the shift fork.

2. The shift mechanism for the manual transmission according to claim 1, wherein the inertia lever is fixed at the shaft and extends in a radial direction of the shaft.

3. The shift mechanism for the manual transmission according to claim 1, wherein the inertia lever made of a thick plate is fixed at the shaft and includes guide groove extending in a radial direction of the inertia lever, with which a protrusion, which is integrally formed at the inertia mass, is engaged so as to be slidable in a longitudinal direction of the inertia lever.

4. The shift mechanism for the manual transmission according to claim 2, wherein the inertia lever made of a thick plate is fixed at the shaft and includes a guide groove extending in a radial direction of the inertia lever, with which a protrusion, which is integrally provided at the inertia mass, is engaged so as to be slidable in a longitudinal direction of the inertia lever.

5. The shift mechanism for the manual transmission according to claim 1, wherein the shaft is rotated in both directions via a shift cable in order to reciprocate the shift rail.

6. The shift mechanism for the manual transmission according to claim 2, wherein the shaft is rotated in both directions via a shift cable in order to reciprocate the shift rail.

7. The shift mechanism for the manual transmission according to claim 3, wherein the shaft is rotated in both directions via a shift cable in order to reciprocate the shift rail.

8. The shift mechanism for the manual transmission according to claim 4, wherein the shaft is rotated in both directions via a shift cable in order to reciprocate the shift rail.

9. The shift mechanism for the manual transmission according to claim 5, wherein a shifter arm is integrally formed at the inertia lever, and an end of the shift cable is connected to an end portion of the shifter arm.

10. The shift mechanism for the manual transmission according to claim 6, wherein a shifter arm is integrally formed at the inertia lever, and an end of the shift cable is connected to an end portion of the shifter arm.

11. The shift mechanism for the manual transmission according to claim 7, wherein a shifter arm is integrally formed at the inertia lever, and an end of the shift cable is connected to an end portion of the shifter arm.

12. The shift mechanism for the manual transmission according to claim 8, wherein a shifter arm is integrally formed at the inertia lever, and an end of the shift cable is connected to an end portion of the shifter arm.
